(19) United States
(12) Patent Application Publication
(10) Pub. No.: US 2018/0120865 A1
(43) Pub. Date: May 3, 2018

(54) SYSTEMS AND METHODS FOR DETECTING SOLID PARTICLES

(71) Applicant: General Electric Company, Schenectady, NY (US)

(72) Inventors: Lily Nuryaningsih, Edmond, OK (US); Vimal Vinod Shah, Sugar Land, TX (US); Mahendra Ladharam Joshi, Katy, TX (US)

(21) Appl. No.: 15/339,561

(22) Filed: Oct. 31, 2016

(51) Int. Cl. G05D 7/06; G01N 29/04; G05B 15/02

(52) U.S. Cl. CPC G05D 7/0676; G01N 29/046; G01N 2291/02836; G01N 2291/02416; G05B 15/02

(57) ABSTRACT

A solids detector may include a receptor configured to extend at least partially into a flow path of a fluid through a conduit. Further, the solids detector may include a sensor configured to receive an acoustic wave generated due to one or more solid particles in the fluid impacting the receptor. Additionally, the sensor may be configured to generate an electrical signal based on the acoustic wave. The electrical signal may be indicative of one or more impact energies of the one or more solid particles that impacted the receptor.

### BACKGROUND

The subject matter disclosed herein relates to systems and methods for detecting solids in a fluid.

Hydrocarbon fluids, such as oil and gas, may be found in subterranean formations located beneath the Earth's surface. In order to obtain the hydrocarbon fluids, a well may be drilled to create a passage between the subterranean formation and the surface where hydrocarbon fluids are to be collected. Hydraulic fracturing (often referred to as fracking or fracing) is a process commonly used to increase the flow of hydrocarbon fluids from a subterranean formation. Hydraulic fracturing involves pumping a fluid (e.g., a fracturing fluid) containing a proppant (e.g., sand) into a subterranean formation at a high pressure. The high pressure fracturing fluid may create fractures (e.g., cracks) in the subterranean formation and/or may increase the size of pre-existing fractures in the subterranean formation to facilitate the release of oil and gas from the subterranean formation. The fluid produced from the well (e.g., production fluid) may include oil, gas, and water, and the production fluid may be routed to various processing equipment, such as one or more separators to separate the oil, gas, and water of the production fluid into separate components. In some instances, the production fluid may also include solid particles, such as the proppant from the hydraulic fracturing fluid. The solid particles in the production fluid may erode or damage various equipment, such as pipelines, valves, and oil/gas/water separators.

### BRIEF DESCRIPTION

In one embodiment, a solids detector includes a valve including a valve body configured to be coupled to a conduit. The valve is configured to control a flow of a fluid through the conduit. Additionally, the solids detector includes a receptor coupled to the valve body and configured to extend at least partially into a flow path of the fluid through the valve body. Further, the solids detector includes a sensor coupled to the valve body and the receptor. The sensor is configured to receive an acoustic wave generated due to one or more solid particles in the fluid impacting the receptor. Additionally, the sensor is configured to generate an electrical signal based on the acoustic wave. The electrical signal is indicative of one or more impact energies of the one or more solid particles that impacted the receptor.

In one embodiment, a system configured to produce oil and gas from a well includes a conduit configured to flow a fluid produced by the well. Additionally, the system includes a solids detector coupled to the conduit and configured to generate an electrical signal in response to detecting one or more solid particles in the fluid. Further, the system includes a controller configured to receive the electrical signal from the solids detector. The controller is also configured to determine an action based at least in part on the electrical signal. The action, when executed, adjusts a flow rate of the fluid through the conduit or adjusts a flow path of the fluid through the system.

In one embodiment, a solids detector includes a receptor configured to extend at least partially into a flow path of a fluid through a conduit. The receptor is configured to generate an acoustic wave in response to one or more solid particles impacting the receptor. The receptor includes a first end and a second end opposite the first end. Additionally, the solids detector includes a first sensor coupled to the first end of the receptor. Further, the solids detector includes a second sensor coupled to the second end of the receptor. The receptor is configured to transfer the acoustic wave to the first and second sensors, and the first and second sensors are configured to generate first and second electrical signals, respectively, based on the acoustic wave. The first and second electrical signals are each indicative of one or more impact energies of the one or more solid particles that impacted the receptor.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an embodiment of a solids management system including one or more solids detectors that may be used with an oil and/or gas production system;

FIG. 2 is a schematic cross-sectional view of an embodiment of a solids detector configured to detect the presence of solid particles entrained in a fluid flow through a conduit;

FIG. 3 is a schematic cross-sectional view of an embodiment of a solids detector including a magnetostrictive sensor;

FIG. 4 is a schematic cross-sectional view an embodiment of a solids detector including a capacitive sensor;

FIG. 5 is a schematic cross-sectional view of an embodiment of a solids detector including a piezoelectric sensor;

FIG. 6 illustrates an embodiment of an electrical pulse signal that may be generated by a sensor of the solids detector;

FIG. 7 is a schematic cross-sectional view of an embodiment of the solids detector including two sensors;

FIG. 8 is a schematic cross-sectional view of an embodiment of a solids detector including a plurality of piezoelectric sensors;

FIG. 9 is a schematic cross-sectional view of an embodiment of a solids detector including two receptors;

FIG. 10 is a schematic cross-sectional view of the solids detector of FIG. 9 illustrating a distance between the two receptors;

FIG. 11A illustrates a perspective view of an embodiment of the solids detector inserted in a butterfly valve, where a receptor of the solids detector is coupled to a sensor of the solids detector;

FIG. 11B illustrates a perspective view of an embodiment of the solids detector inserted in the butterfly valve, where the receptor and the sensor of the solids detector are integrally formed;

FIG. 12A illustrates a cross-sectional view of an embodiment of the solids detector inserted in a ball valve, where a receptor of the solids detector is coupled to a sensor of the solids detector;

FIG. 12B illustrates a cross-sectional view of an embodiment of the solids detector inserted in the ball valve, where the receptor and the sensor of the solids detector are integrally formed;

FIG. 13A illustrates a cross-sectional view of an embodiment of the solids detector inserted in a globe valve, where a receptor of the solids detector is coupled to a sensor of the solids detector;

FIG. 13B illustrates a cross-sectional view of an embodiment of the solids detector inserted in the globe valve, where the receptor and the sensor of the solids detector are integrally formed;

FIG. 14A illustrates a cross-sectional view of an embodiment of the solids detector inserted in a gate valve, showing the gate valve in a closed position; and

FIG. 14B illustrates a cross-sectional view of an embodiment of the solids detector inserted in the gate valve, showing the gate valve in an open position.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Certain embodiments or implementations illustrating aspects of the present disclosure are described and/or depicted with reference to the present figures. It should be understood, however, that there is no intent to limit example embodiments to the particular forms disclosed, but to the contrary, example embodiments are to cover all modifications, equivalents, and alternatives falling within the scope of the present invention. Indeed, the present examples are intended to facilitate and simplify explanation of the present approach and to provide useful context for understanding the disclosed subject matter. These description and example should, therefore, not be read to explicitly or implicitly limit application of the described devices and/or techniques to the contexts of the examples.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

The present discussion relates to the use of solid detectors (e.g., solid measurement devices or solid sensors) to detect solid particles in a fluid flow and/or to measure one or more characteristics of solid particles in a fluid flow. For example, in certain embodiments, the disclosed solid detector may measure a volume, quantity, concentration, and/or size distribution of solid particles in a fluid flow. In some embodiments, the solids detector may include a receptor that is configured to be impacted by solid particles in the fluid flow. Additionally, the solids detector may include a sensor that is configured to generate an electrical signal based on an acoustic wave generated in response to the solid particles impacting the receptor. In some embodiments, the sensor may include the receptor. In certain embodiments, the sensor may be affixed to the receptor, and the receptor may be configured to transfer the generate acoustic wave to the sensor. In some embodiments, the receptor and the sensor of the solids detector may be coupled to a valve body of a valve.

Additionally, as discussed below, the electrical signal generated by the sensor may be used to control a system having the fluid to reduce erosion and/or damage that may result from the solid particles in the fluid. In some embodiments, a controller of the system may determine one or more actions based on an analysis of the electrical signal, and the one or more actions, when executed, may reduce or block damage to one or more components of the system. In certain embodiments, the one or more actions may adjust a flow rate of the fluid in the system or a flow path of the fluid through the system. For example, the one or more actions may include adjusting a position of a choke to adjust a flow rate of the fluid or adjusting a position of a valve disposed in a conduit configured to flow the fluid to adjust a flow path of the fluid through the system.

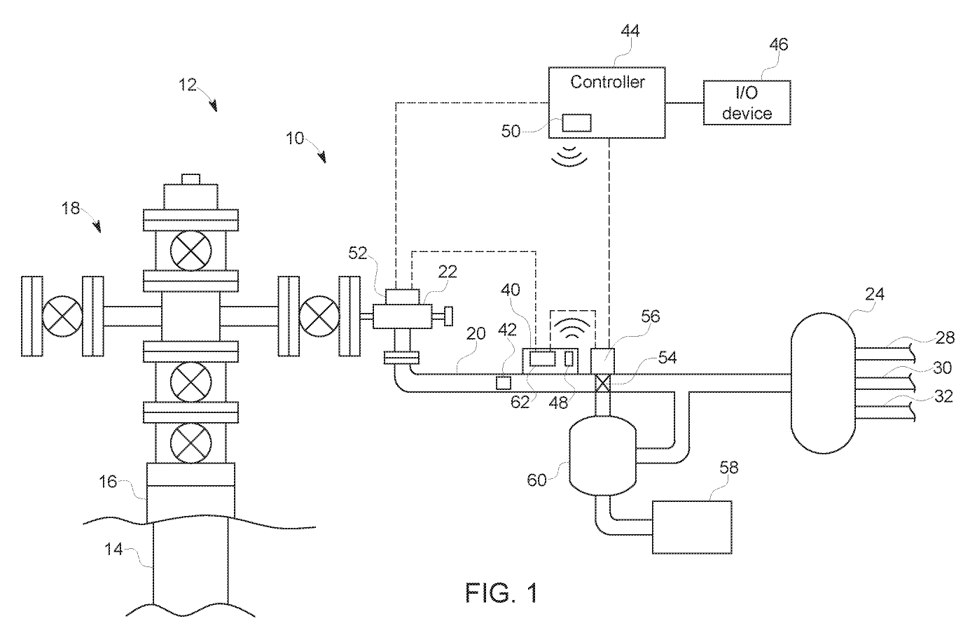

Turning to the figures, FIG. 1 illustrates an embodiment of a solids management system 10 configured to detect solid particles (e.g., solids, sand, rocks, proppant, ceramic particles, etc.) in a fluid flow. In the illustrated embodiment, the solids management system 10 is used with an oil and/or gas production system 12 configured to extract or produce oil and/or gas from a well 14 (e.g., an oil well and/or a gas well) extending into a subterranean formation containing oil and/or gas. However, it should be appreciated that the solids management system 10 may be used with any suitable system configured to flow a fluid that may include one or more solid particles.

The oil and/or gas production system 12 may include a wellhead 16 configured to establish fluid communication with the well 14. Additionally, the oil and/or gas production system 12 may include a tree 18 (e.g., a production tree, a Christmas tree, etc.) configured to couple to the wellhead 16. The tree 18 may include a variety of flow paths, valves, fittings, and controls for controlling the flow of fluids into and out of the well 14. During operation, the tree 18 may route fluids (e.g., production fluid) produced by the well 14 to a production flowline 20. The production fluid may include oil, gas, and/or water.

In some embodiments, the tree 18 may be coupled to the production flowline 20 via a flow control device 22 (e.g., a choke, a choke valve). In some embodiments, the tree 18 may include the flow control device 22. The flow control device 22 may be configured to control the flow of the production fluid from the well 14 and/or to control the pressure in the well 14. For example, in some embodiments, decreasing the size of an opening of the flow control device 22 may decrease the flow rate of the production fluid from the well 14 and may increase the pressure in the well 14. Additionally, increasing the size of the opening of the flow control device 22 may increase the flow rate of the production fluid from the well 14 and may decrease the pressure in the well 14.

The production flowline 20 may be configured to route the production fluid to one or more oil and/or gas processing devices 24 (e.g., fluid processing devices). It should be appreciated that while the production flowline line 20 is illustrated as a single flowline, the production flowline 20 may include two or more flowlines (e.g., conduits, pipes, pipelines, jumpers, risers, etc.). Further, it should be appreciated that while the production flowline line 20 is illustrated as directly coupled to the one or more oil and/or gas processing devices 24, the production flowline 20 may be coupled to (e.g., indirectly coupled to) the one or more gas/processing devices 24 via one or more intermediate components (e.g., manifolds, pipeline end terminations, etc.).

In certain embodiments, the one or more oil and/or gas processing devices 24 may include distillation columns, rotating machinery, pumps, compressors, heat exchangers, separators, or any other suitable equipment. For example, as illustrated, the one or more oil and/or gas processing devices 24 may include one or more separators (e.g., gas/liquid separators, liquid/liquid separators, oil/gas/water separators, etc.) configured to separate oil, gas, and water in the production fluid into separate components. The one or more separators may be configured to route the oil to an oil flowline 28, the gas to a gas flowline 30, and the water to a water flowline 32.

As noted above, the production fluid may include oil, gas, and/or water. In some situations, the production fluid may also include solid particles, such as sand and/or rocks from the subterranean formation. In some embodiments, the oil and/or gas production system 12 may include a hydraulic fracturing system (e.g., a fracking system or fracing system), which may be configured to increase the production of oil and/or gas from the well 14 by pumping a fluid (e.g., a fracturing fluid) containing a proppant (e.g., solid particles, sand, ceramic particles, etc.) into the subterranean formation at a high pressure. In particular, the high pressure fracturing fluid may create fractures (e.g., cracks) in the subterranean formation and/or may increase the size of pre-existing fractures in the subterranean formation to facilitate the release of oil and gas from the subterranean formation. While most of the injected fracturing fluid may remain underground, a portion of the injected fracturing fluid may return to the surface and is typically referred to as “flowback.” As such, the production fluid may include proppant from the fracturing fluid. The solid particles in the production fluid may erode and/or damage various components of the oil and/or gas production system 12, such as the production flowline 20, the one or more oil and/or gas processing devices 24, and/or the flow control device 22, which may reduce the life of the various components and may increase the downtime and operating costs of the oil and/or gas production system 12 associated with repairing and/or replacing damaged components.

As discussed below, the solids management system 10 may be configured to detect solid particles in the production fluid and/or to measure one or more parameters of the solid particles in the production fluid, such as the volume, quantity, concentration, and/or size distribution of solid particles in the production fluid. Additionally, as discussed below, the solids management system 10 may be configured to determine one or more actions (e.g., control actions, operational decisions, etc.) based on the detection of solid particles in the production fluid and/or based on the measured parameters of the solid particles in the production fluid. In particular, the solids management system 10 may be configured to determine one or more actions that, when executed, may reduce, block, or prevent erosion and/or damage to one or more components of the oil and/or gas production system 12 caused by solid particles in the production fluid. Further, the solids management system 10 may be configured to automatically execute the one or more determined actions and/or to provide user-perceivable indications indicative of the one or more determined actions to a user (e.g., via an output device), which may prompt the user to execute the one or more determined actions. As such, the solids management system 10 may facilitate the reduction of damage to one or more components of the oil and/or gas production system 12 caused by solid particles in the production fluid, which may increase the life of the one or more components and may decrease the downtime and operating costs of the oil and/or gas production system 12.

With the foregoing in mind, the solids management system 10 may include one or more solids detectors 40 (e.g., solids measurement devices, solids sensors, sand detectors, etc.) configured to detect the presence of one or more solid particles in the production fluid. In certain embodiments, the one or more solids detectors 40 may be configured to measure one or more parameters of the solid particles in the production fluid, such as a volume, quantity, concentration, and/or size distribution of solid particles in the production fluid. In some embodiments, the one or more solids detectors 40 may be configured to measure flow rate of the production fluid. In certain embodiments, the solids management system 10 may include one or more flow meters 42 configured to measure the flow rate of the production fluid.

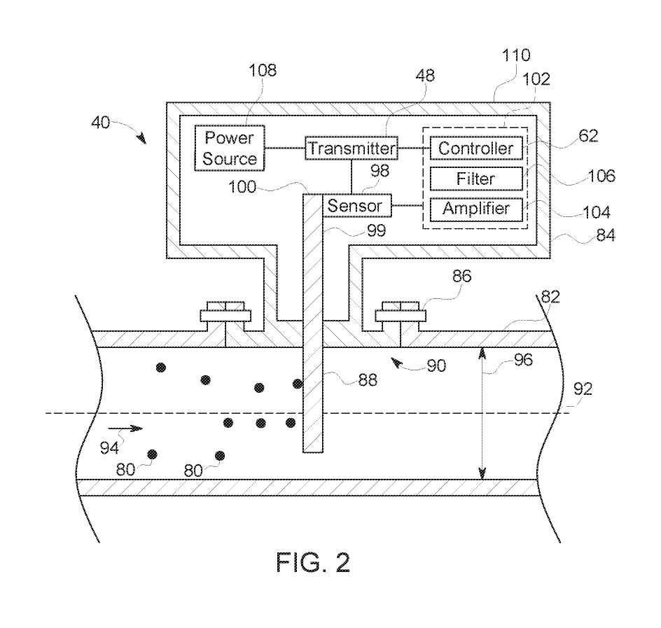

As discussed in below with respect to FIGS. 2-6, in some embodiments, the one or more solids detectors 40 may include acoustic sensors (e.g., acoustic wave sensors) that are configured to convert an acoustic wave (e.g., a mechanical wave or a stress wave) into an electrical signal. However, it should be appreciated the solids management system 10 may include any suitable type of solids detectors 40, such as accelerometers, laser diffraction sensors, sonar sensors, ultrasonic sensors, Doppler effect sensors, optical sensors (e.g., infrared sensors, fiber optic sensors, etc.), and so forth. The solids detectors 40 and the flow meters 42 may be disposed about any suitable location of the oil and/or gas production system 12 to monitor the production fluid. In some embodiments, the solids detectors 40 and the flow meters 42 may be disposed downstream of the well 14 and upstream of the one or more oil and/or gas processing devices 24. For example, one or more solids detectors 40 and/or one or more flow meters 42 may be disposed in or on the production flowline 20, the flow control device 22, the tree 18, and/or the wellhead 16.

In some embodiments, the solids management system 10 may include a controller 44, which may include or may be operatively coupled to an input/output (I/O) device 46 configured to receive inputs from a user and/or to provide information to a user. For example, the I/O device 46 may include a display, computer, monitor, cellular or smart phone, tablet, other handheld device, speaker, keyboard, or the like. The controller 44 may be configured to receive data (e.g., signals, sensor feedback, etc.) from the one or more solids detectors 40. For example, one or more solids detectors 40 may include a wireless transmitter 48 (e.g., a wireless transceiver) configured to wirelessly transmit data to a wireless receiver 50 (e.g., a wireless transceiver) of the controller 44. In certain embodiments, the wireless transmitter 48 may be configured to wirelessly transmit the data to a cloud-based system (e.g., a cloud server, a cloud storage device, etc.), and the controller 44 may be configured to download the data from the cloud-based system. In some embodiments, one or more solids detectors 40 may be communicatively coupled to the controller 44 via a wired connection (e.g., a cable). Additionally, the controller 44 may be configured to receive data from the one or more flow meters 42 via a wireless connection (e.g., a wireless transmitter of the flow meter 42), via a wired connection, or via the cloud-based system.

The solids detectors 40 may be configured to transmit raw data, processed data, and/or measured parameters of the solid particles in the production fluid to the controller 44. In certain embodiments, the controller 44 may be configured to determine one or more parameters of the solid particles in the production fluid (e.g., solids parameters), such as volume, quantity, concentration, and/or size distribution, based on raw and/or processed data from the solids detectors 40. Additionally, the controller 44 may cause the I/O device 46 to provide one or more user-perceivable indications relating to the one or more solids parameters. For example, the controller 44 may cause the I/O device 46 to display the one or more measured solids parameters. The measured solids parameters may facilitate a user in assessing possible erosion of the oil and/or gas production system 12, as well as assessing the subterranean formation and the hydraulic fracturing operation.

Further, in some embodiments, the controller 44 may be configured to determine one or more actions (e.g., a control actions, an operational decision, etc.) based on the detection of solid particles in the production fluid and/or based on the measured solids parameters. In particular, the controller 44 may determine one or more actions that, when executed, may reduce, block, or prevent erosion and/or damage to one or more components of the oil and/or gas production system 12 caused by solid particles in the production fluid. For example, erosion and/or damage may be reduced, blocked, or prevented by stopping the flow of the production fluid from the well 14 or by reducing the flow rate of the production fluid from the well 14. Additionally, erosion and/or damage may be reduced by increasing the pressure in the well 14. In particular, the pressure differential between the well 14 and the surrounding subterranean formation may cause sand to flow from the subterranean formation to the well 14. Thus, increasing the pressure of the well 14 may decrease the pressure differential, thereby reducing the likelihood of sand entering the well 14 from the subterranean formation. As noted above, the size of the opening of the flow control device 22 (e.g., choke) may adjusted to adjust the flow of production fluid from the well 14 and the pressure in the well 14. In some embodiments, an actuator 52 may be configured to adjust the size of the opening of the flow control device 22. In certain embodiments, the actuator 52 may include one or more of a manual actuator, an electric actuator, a hydraulic actuator, or a pneumatic actuator.

Accordingly, in some embodiments, the controller 44 may determine that the size of the opening of the flow control device 22 should be adjusted (e.g., reduced) to reduce the flow rate of production fluid from the well 14, to stop the flow of production fluid from the well 14 (e.g., during well shut down or well shut-in), or to increase the pressure in the well 14 based on an analysis of one or more measured solids parameters. For example, the controller 44 may determine that the size of the opening of the flow control device 22 should be adjusted (e.g., reduced) in response to a determination that one or more measured solid parameters violate a respective threshold (e.g., greater than an upper threshold or less than a lower threshold). In certain embodiments, the controller 44 may determine that the size of the opening of the flow control device 22 should be adjusted (e.g., increased) to increase the flow rate of production fluid from the well 14 and/or to decrease the pressure of fluid from the well 14 in response to a determination that the one or more measured solids parameters do not violate respective thresholds.

In some embodiments, the controller 44 may determine a size for the opening of the flow control device 22 based on an analysis of one or more measured solids parameters, such as by comparing one or more measured solids parameters to one or more respective thresholds. For example, the controller 44 may compare a measured solids parameter to a plurality of tiered or graded thresholds that successively increase in value, and each threshold may be associated with a size for the opening of the flow control device 22. By way of example, the controller 44 may determine a first size for the opening if a measured solids parameter is greater than a first threshold. Additionally, the controller 44 may determine a second size for the opening that reduces the flow rate of the production fluid from the well 14 and increases the pressure in the well 14 as compared to the first size if the measured solids parameter is greater than a second threshold that is greater than the first threshold.

Further, in some embodiments, the controller 44 may determine that the flow rate of production fluid from the well 14 should be reduced and/or the pressure in the well 14 should be increased to a greater extent in response to a determination that two or more measured solids parameters each violate a respective threshold. For example, the controller 44 may compare a first solids parameter (e.g., size or diameter of the solid particles) to a first threshold associated with a first size of the opening and may compare a second solids parameter (e.g., flow rate, concentration, etc.) to a second threshold associated with a second size of the opening. In certain embodiments, the controller 44 may determine that the opening of the flow control device 22 should be adjusted to a third size that results in a reduced production fluid flow rate and an increased well pressure as compared to the first and second sizes in response to a determination that the first and second measured solids parameters each violate the respective threshold.

Additionally, erosion and/or damage to components of the oil and/or gas production system 12 may be reduced, blocked, or prevented by adjusting the flow path of the production fluid through the oil and/or gas production system 12. For example, erosion and/or damage to the oil and/or gas processing devices 24 may be reduced, blocked, or prevented by diverting the flow of the production fluid from the oil and/or gas processing devices 24. In some embodiments, the oil and/or gas production system 12 may include a bypass valve 54 disposed in the production flow line 20 that may be controlled to divert the production fluid from the oil and/or gas processing devices 24. For example, the bypass valve 54 that may be configured to route the production fluid to the oil and/or gas processing devices 24 when the bypass valve 54 is in a first position (e.g., an open position) and to divert the production fluid away from the oil and/or gas processing devices 24 when the bypass valve 54 is in a second position (e.g., a closed position). In certain embodiments, an actuator 56 may be configured to adjust the position of the bypass valve 54. In some embodiments, the actuator 56 may include one or more of a manual actuator, an electric actuator, a hydraulic actuator, or a pneumatic actuator. Further, in some embodiments, the bypass valve 54 may be configured to route the production fluid to a solids tank 58 (e.g., a sand tank, a frack tank, etc.) when the bypass valve 54 is in the second position. In certain embodiments, the bypass valve 54 may be configured to route the production fluid to a solids separator 60 (e.g., a sand separator) configured to separate or remove the solid particles from the production fluid. The separated solid particles may be routed from the solids separator 60 to the solids tank 58. In certain embodiments, the resulting production fluid (e.g., containing oil, gas, and/or water) may be routed from the solids separator 60 to the oil and/or gas processing devices 24.

Accordingly, in some embodiments, the controller 44 may determine that the production fluid should be diverted from the oil and/or gas processing devices 24 in response to a determination that the production fluid includes solid particles or in response to a determination that one or more measured solids parameters violates a respective threshold. For example, the controller 44 may determine that the bypass valve 54 should be actuated to the second position in response to a determination that the production fluid includes solid particles or in response to a determination that one or more measured solids parameters violates a respective threshold. Further, the controller 44 may continue to monitor the production fluid while the bypass valve 54 is in the second position to determine when the bypass valve 54 should be actuated to the first position. For example, the controller 44 may determine that the bypass valve 54 should be actuated to the first position in response to a determination that the production fluid does not include solid particles or in response to a determination that the measured solids parameters do not violate respective thresholds.

Further, in some embodiments, the controller 44 may cause the I/O device 46 to provide user-perceivable indications (e.g., alerts, alarms, messages, graphical indications, etc.) indicative of the one or more determined actions (e.g., adjusting the size of the opening of the flow control device 22 and/or adjusting the position of the bypass valve 54) to a user. For example, the controller 44 may cause the I/O device 46 to display the one or more determined actions, which may prompt the user to execute the one or more determined actions. For example, the user may manually adjust the actuator 52 to adjust the size of the opening of the flow control device 22 and/or may manually adjust the actuator 56 to adjust the position of the bypass valve 54.

In certain embodiments, the controller 44 may be configured to automatically execute the one or more determined actions. For example, the controller 44 may be configured to send a control signal (e.g., a wired and/or wireless control signal) to the actuator 52, which may cause the actuator 52 to adjust the size of the opening of the flow control device 22 (e.g., to a size specified by the control signal). Additionally, the controller 44 may 44 may be configured to send a control signal (e.g., a wired and/or wireless control signal) to the actuator 56, which may cause the actuator 56 to adjust the position of the bypass valve 54.

In some embodiments, the solids detector 40 may include a controller 62 configured to perform one or more of the above-described functions of the controller 44. For example, the controller 62 may determine one or more actions (e.g., adjusting the size of the opening of the flow control device 22 and/or adjusting the position of the bypass valve 54) based on the detection of solid particles in the production fluid and/or based on the measured solids parameters, as discussed above with respect to the controller 44. Additionally, in certain embodiments, the controller 62 may be configured to automatically execute the determined actions, as discussed above with respect to the controller 44. Further, in certain embodiments, the controller 62 may be configured to cause the I/O device 46 to display the determined actions. For example, the controller 62 may transmit the determined actions to the controller 44, which may cause the I/O device 46 to display the determined actions. In some embodiments, the controller 44 may determine the actions and may cause the controller 62 to execute the determined actions. Further, in certain embodiments, a user may input a desired action via the I/O device 46, and the controller 44 and/or the controller 62 may be configured to execute the action inputted by the user. For example, the user may determine an action based on one or more measured solids parameters displayed on the I/O device 46.

FIG. 2 illustrates a schematic of an embodiment of the solids detector 40 configured to acoustically detect the presence of one or more solid particles 80 entrained in a fluid flowing through a conduit 82 (e.g., a pipe, a flowline, etc.). In some embodiments, the conduit 82 may be the production flowline 20 that is configured to flow the production fluid from the wellhead assembly 18. The solid particles 80 may include sand particles, ceramic particles, proppant, rocks, and/or debris.

As illustrated, the solids detector 40 may include a housing 84 (e.g., body) that is configured to be coupled to the conduit 82. In certain embodiments, the housing 84 may be coupled to the conduit 82 via one or more fasteners 86, such as one or more bolts, screws, nuts, threaded connections, and the like. While the housing 84 is illustrated as a single structural component in FIG. 2, in some embodiments, the housing 84 may include two or more structural components, which may be coupled to one another. In some embodiments, the housing 84 may include a flange, such as a blind flange (e.g., a plate) configured to cover an end of the conduit 82, or a flange joint (e.g., a ring) configured to couple the conduit 82 to another conduit. Further, as discussed below, in some embodiments, the housing 84 may include the housing (e.g., body) of a valve, such as a butterfly valve, a ball valve, a globe valve, or a gate valve, or the housing of a flowmeter, such as the flowmeter 42.

Additionally, the solids detector 40 may include a receptor 88 (e.g., a probe, a rod, etc.) configured to be impacted by one or more of the solid particles 80 entrained in the fluid. As illustrated, the receptor 88 may extend through an opening 90 formed in the conduit 82 when the housing 84 is coupled to the conduit 82. In some embodiments, the receptor 88 may be coupled to the housing 84. In some embodiments, the receptor 88 may extend substantially crosswise (e.g., perpendicular) to a longitudinal axis 92 of the conduit 84 and/or crosswise to a flow direction 94 of the fluid through the conduit 82. In some embodiments, the receptor 88 may extend across at least 50%, 60%, 70%, 80%, or 90% of a diameter 96 of the conduit 82. In certain embodiments, as discussed below, the receptor 88 may extend across the entire diameter 96. In some embodiments, the receptor 88 may be cylindrical, rectangular, or any other suitable shape.

Further, the solids detector 40 may include one or more sensors 98 (e.g., an acoustic sensor, an acoustic wave sensor) configured to convert acoustic waves (e.g., mechanical waves, stress/strain waves, vibrations, etc.) into electrical signals. For example, as discussed below, the one or more sensors 98 may include a magnetostrictive sensor, a piezoelectric sensor, an accelerometer, and/or a capacitive sensor. The one or more sensors 98 may be acoustically coupled to the receptor 88. For example, in some embodiments, the one or more sensors 98 may be in physical (e.g., mechanical) contact with and/or coupled to (e.g., affixed to) the receptor 88. As illustrated, in some embodiments, the sensor 98 may abut and/or be coupled to a radial surface 99 of the receptor 88 relative to the longitudinal axis 92 of the conduit 82. In certain embodiments, the sensor 98 may abut and/or may be coupled to an axial surface 100 of the receptor 88 relative to the longitudinal axis 92 of the conduit 82. In some embodiments, as discussed below, the sensor 98 and the receptor 88 may be integrally formed. For example, the sensor 98 may include the receptor 88. In certain embodiments, one or more sensors 98 may be coupled to and supported by the housing 84. Additionally, the one or more sensors 98 may be non-rated (e.g., not wet, not exposed to the flow of fluid through the conduit 82). For example, in some embodiments, one or more sensors 98 may be external to the conduit 82 (e.g., disposed in the housing 94). In certain embodiments, as discussed below, one or more sensors 98 may be embedded in the receptor 88 such that the one or more sensors 98 are disposed in the conduit 82 and blocked from the fluid through the conduit 82 by the receptor 88.

During operation, an acoustic wave (e.g., a mechanical wave, a stress/strain wave, a vibration, etc.) may be generated due to one or more of the solid particles 80 impacting the receptor 88. The receptor 88 may transfer the generated acoustic wave to sensor 98. The sensor 98 may generate an electrical signal (e.g., an electrical pulse signal, an output signal, etc.) based on the acoustic wave generated in response to one or more solid particles 80 impacting the receptor 88, and the electrical signal may vary with (e.g., be proportional to) the impact energies of the one or more solid particles 80 that impacted the receptor 88. As discussed below, the electrical signal may include current, voltage, capacitance, frequency, and/or magnetic field (e.g., magnetic field strength or flux). The impact energy and, by extension, the generated electrical signal may vary with (e.g., be proportional to) the flow rate of the solid particles 80 and the mass of the solid particles 80, which may be correlated with the size (e.g., diameter or volume) of the solid particles 80. Accordingly, as discussed below, the electrical signal may be used to determine one or more parameters of the solid particles 80, such as the mass, size (e.g., diameter, volume, etc.), density, flow rate, quantity, and/or concentration.

In certain embodiments, the receptor 88 may be rigidly coupled to the housing 84 such movement of the receptor 88 relative to the housing 84 is reduced, minimized, or blocked. Additionally, in some embodiments, the receptor 88 may be made from one or more rigid (e.g., stiff) and/or abrasion resistant materials, such as tungsten carbide, silicon carbide, steel (carbon steel, stainless steel, etc.), and so forth. In some embodiments, the receptor 88 may be coated with an abrasion resistant coating. The stiffness or rigidity of the receptor 88 may facilitate the detection of very small impact forces on the receptor 88 and the transfer of acoustic waves generated in response to very small impact forces to the sensor 98. Additionally, it may be desirable to form the receptor 88 from one or more materials that are resistant to abrasion, such as tungsten carbide, silicon carbide, or steel, to reduce erosion of the receptor 88 due to the solid particles 80. In some embodiments, a blind flange (e.g., a plate) configured to cover an end of the conduit 82 may be used as the receptor 88 Further, in some embodiments, as discussed below, the receptor 88 may be formed from one or more conductive materials, such as one or more metals.

In some embodiments, the solids detector 40 may include circuitry 102 (e.g., data acquisition circuitry, processing circuitry, and/or control circuitry). For example, the circuitry 102 may be configured to receive the electrical signal from the sensor 98. In some embodiments, the circuitry 102 may include one or more amplifiers 104 configured to amplify the received electrical signal and/or one or more filters 106 configured to filter the received electrical signal. In some embodiments, the circuitry 102 (e.g., the controller 62) may be configured to dynamically adjust the amplifiers 104 based on the flow rate of the solid particles 80, which may be determined by the solids detector 40 or the flowmeter 42. For example, as discussed below, the one or more filters 106 may be configured to filter the electrical signal based on frequency and/or amplitude, and different frequencies or amplitudes may be correlated with different particle sizes (e.g., diameter, volume, etc.) and/or masses. Further, in some embodiments, the circuitry 102 may include the controller 62. As discussed below, in some embodiments, the controller 62 may be configured to determine one or more parameters of the solid particles 80, such as the mass, size (e.g., diameter, volume, etc.), density, flow rate, quantity, and/or concentration, based on the electrical signal. Additionally, as discussed above, the controller 62 may be configured to determine the one or more actions based on the parameters and/or to execute the one or more actions.

Further, as noted above, the solids detector 40 may include the transmitter 48. The transmitter 48 may be configured to wirelessly transmit a raw (e.g., unprocessed) electrical signal, a processed (e.g., amplified and/or filtered) electrical signal, and/or one or more determined parameters to the controller 44 and/or to a cloud-based system. In certain embodiments, the solids detector 40 may be communicatively coupled to the controller 44 via a wired connection. Further, in some embodiments, the solids detector 40 may include a power source 108 (e.g., a battery, a capacitor, etc.), which may be configured to power the sensor 98, the transmitter 48, and/or the controller 62. The transmitter 48, the circuitry 102, and the power source 108 may be coupled to the housing 84. For example, as illustrated, the transmitter 48, the circuitry 102, and the power source 108 may be disposed within the housing 84. In some embodiments, the transmitter 48, the circuitry 102, and/or the power source 108 may be coupled to an outer surface 110 of the housing 84.

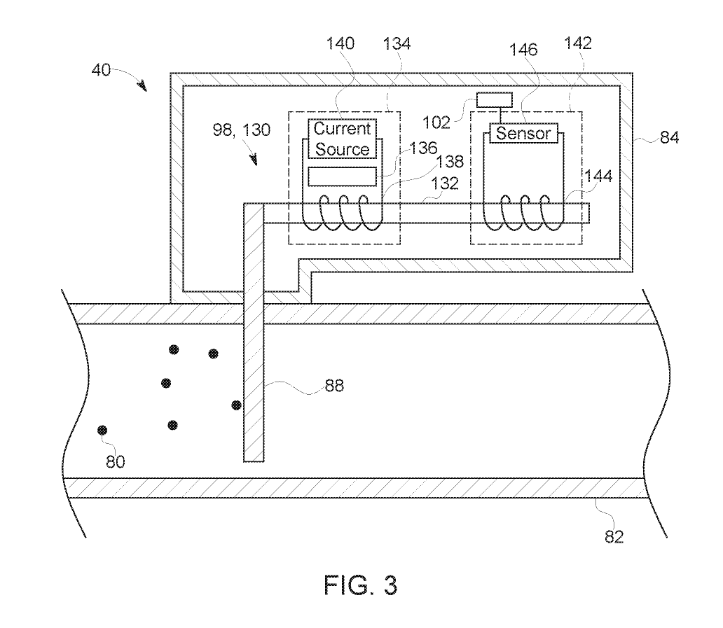

FIG. 3 illustrates a schematic of an embodiment of the solids detector 40 where the sensor 98 includes a magnetostrictive sensor 130 (e.g., an inverse magnetostrictive sensor, an inverse magnetostrictive load sensor, etc.). The magnetostrictive sensor 130 may include a magnetostrictive element 132 (e.g., a magnetostrictive core) made of a magnetostrictive material, such as an alloy of nickel and iron (e.g., Terfenol-D) or an alloy of iron and gallium (e.g., Galfenol). As illustrated, the magnetostrictive element 132 may be in physical contact with and/or coupled to the receptor 88. As such, the receptor 88 may transfer an acoustic wave (e.g., a stress/strain wave) generated due to one or more solid particles 80 impacting the receptor 88 to the magnetostrictive element 132.

Additionally, the magnetostrictive sensor 130 may include a magnetic field generating device 134 configured to generate one or more magnetic fields. For example, in some embodiments, the magnetic field generating device 134 may include one or more magnet 136 (e.g., permanent magnets and/or electromagnets) configured to generate a constant magnetic field. Additionally or alternatively, the magnetic field generating device 134 may include a conductive coil 138 (e.g., an excitation coil) and a current source 140 that provides a current to the conductive coil 138 to generate a magnetic field. The current source 140 provide an alternating current (AC) to generate an AC magnetic field or a direct current (DC) to generate a DC magnetic field. As illustrated, the conductive coil 138 may surround the magnetostrictive element 132.

The magnetic field generating device 134 may induce a magnetic field (e.g., a magnetic flux) in the magnetostrictive element 132. Magnetostrictive materials can change shape or size in response to an applied magnetic field, which is typically referred to as the magnetostrictive effect or the direct magnetostrictive effect. Additionally, the magnetic susceptibility or permeability of magnetostrictive materials can change in response to an applied force (e.g., mechanical stress), which is typically referred to as the inverse magnetostrictive effect or the Villari effect. The acoustic wave transferred to the magnetostrictive element 132 may apply a force on the magnetostrictive element 132, which may change the magnetic susceptibility or permeability of the magnetostrictive element 132 in accordance with the inverse magnetostrictive effect. The change in magnetic susceptibility or permeability of the magnetostrictive element 132 may cause a change in the magnetic field (e.g., magnetic flux) induced in the magnetostrictive element 132.

Additionally, the magnetostrictive sensor 130 may also include a magnetic field detecting device 142 (e.g., a magnetometer) configured to detect a change in the magnetic flux. For example, the magnetic field detecting device 142 may include a conductive coil 144 (e.g., a sensing coil), which may surround the magnetostrictive element 132, and a sensor 146 (e.g., a current sensor or a voltage sensor) configured to measure the current through the conductive coil 144 or the voltage across the conductive coil 144. Specifically, the change in the magnetic flux may induce a voltage and a current in the conductive coil 144. Accordingly, the induced voltage and/or current may be indicative of and/or correlated to the change in the magnetic flux, the change in the magnetic susceptibility or permeability of the magnetostrictive element 132, the mechanical force (e.g., acoustic wave) applied to the magnetostrictive element 132, and the impact energies of the solid particles 80 that impacted the receptor 88. The magnetostrictive sensor 130 may be configured to output or provide the measured induced voltage or current as the electrical signal to the circuitry 102 and/or the transmitter 48.

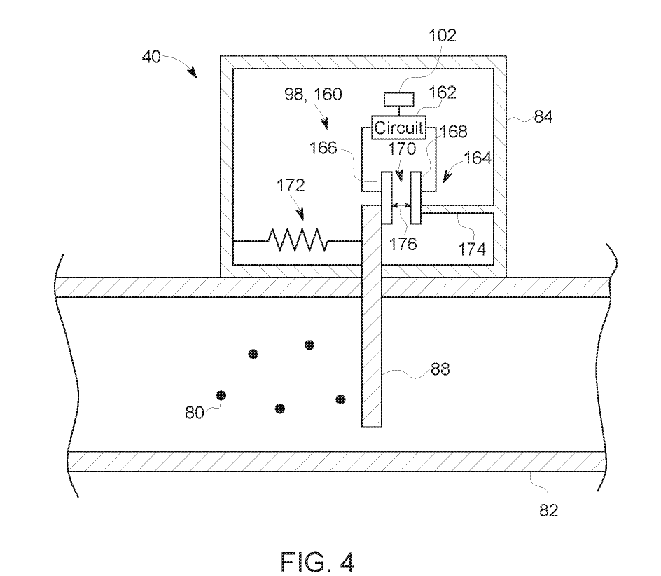

FIG. 4 illustrates an embodiment of the solids detector 40 where the sensor 98 includes a capacitive sensor 160. The capacitive sensor 160 may include a circuit 162 including a capacitor 164. The capacitor 164 may include a first conductive plate 166 and a second conductive plate 168 that are separated from one another by a dielectric 170, such as air. The circuit 162 may include excitation circuitry configured to provide an excitation voltage to charge the capacitor 164 and sensing circuitry configured to measure the capacitance of the capacitor 164.

As illustrated, the first conductive plate 166 may be coupled to (e.g., affixed to) the receptor 88. In some embodiments, the receptor 88 and the first conductive plate 166 may be moveable relative to the housing 84 and the second conductive plate 168. For example, the receptor 88 may be coupled to the housing 84 via a flexible or deformable element, such as a spring 172. Additionally, the second conductive plate 168 may be fixed relative to the housing 84. For example, the second conductive plate 168 may be coupled to the housing 84 via a fixed support 174. As noted above, in some embodiments, the receptor 88 and the sensor 98 may be integrally formed. That is, the sensor 98 may include the receptor 88. For example, in some embodiments, the receptor 88 may be formed from one or more conductive materials, such as one or more metals, and the receptor 88 may include the first conductive plate 166.

As such, the receptor 88 and the first conductive plate 166 may be configured to move relative to the second conductive plate 168 due to one or more solid particles 80 impacting the receptor 88, which may change (e.g., decrease) a distance 176 (e.g., gap) between the first and second conductive plates 166 and 168. As will be appreciated, the capacitance of the capacitor 164 is inversely proportional to the distance 176 between the first and second conductive plates 166 and 168, and thus, the measured capacitance may be indicative of the impact energies of the one or more solid particles 80 that impacted the receptor 88. The capacitive sensor 160 may be configured to output or provide the measured capacitance as the electrical signal to the circuitry 102 and/or the transmitter 48.

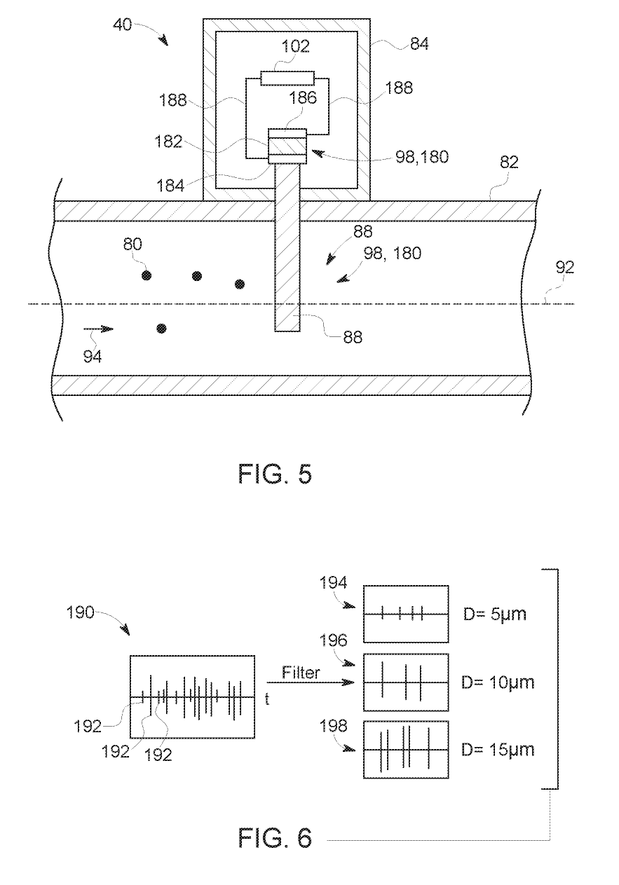

FIG. 5 illustrates an embodiment of the solids detector 40 where the sensor 98 includes a piezoelectric sensor 180. In particular, in the illustrated embodiment, the piezoelectric sensor 180 is coupled to (e.g., affixed to) the receptor 88. The piezoelectric sensor 180 may include a piezoelectric element 182, which may be made of more piezoelectric materials, such as one or more piezoelectric crystals (e.g., quartz, berlinite, gallium orthophosphate, and/or tourmaline), one or more piezoelectric ceramics (e.g., barium titanate and/or lead zirconate titanate), zinc oxide, aluminum nitride, polyvinylidene fluoride, and so forth. Additionally, the piezeoelectric sensor 180 may include first and second electrodes 184 and 186, which may be disposed on opposing surfaces of the piezoelectric element 182. Further, the first electrode 184 or the second electrode may be coupled to a surface (e.g., the radial surface 99 or the axial surface 100) of the receptor 88.

During operation, one or more solid particles 80 may impact the receptor 88, which may generate an acoustic wave in response to the impacts of the one or more solid particles 80. Additionally, the receptor 88 may transfer the acoustic signal to first electrode 184, which may cause a mechanical deformation of the piezoelectric element 182. The piezoelectric element 182 may generate an electrical charge (e.g., a voltage) based on the mechanical deformation. The piezoelectric sensor 180 may be configured to provide or output a voltage signal (e.g., an electrical signal, an electrical pulse signal) indicative of the mechanical deformation and the impact energies of the solid particles 80 that impacted the receptor 88 to the circuitry 102. In particular, the first and second electrodes 184 and 186 may be coupled to the circuitry 102 via leads 188 to provide the voltage signal to the circuitry 102.

FIG. 6 illustrates an embodiment of an electrical pulse signal 190 that may be generated by the sensor 98 (e.g., the magnetostrictive sensor 130, the capacitive sensor 160, or the piezoelectric sensor 180). In some embodiments, the electrical pulse signal 190 may be a raw signal generated by the sensor 98 or a signal generated by the sensor 98 that has been processed (e.g., amplified, filtered, transformed, etc.). As illustrated, the electrical pulse signal 190 may include a plurality of pulses 192 over time. In some embodiments, the pulses 192 may be frequencies or amplitudes. In some embodiments, the solids detector 40 (e.g., the sensor 98) may have a detection frequency between approximately 10 kilohertz (KHz) and one megahertz (MHz). As discussed above, amplitude and/or frequency of each pulse 192 may be based on or correlated to the impact energies of the solid particles 80 that impacted the receptor 88. The pulses 192 may be analyzed using one or more algorithms, mathematical models, databases, and so forth to determine one or more parameters of the solid particles 80, such as size (e.g., diameter or volume), mass, density, flow rate, quantity, concentration, and so forth. For example, in some embodiments, the pulses 192 may be filtered and sorted based on frequency or amplitude (e.g., frequency pulses filtered by frequency and amplitude pulses filtered based on amplitude), where different frequencies or amplitudes are associated with different particle diameters or different particle masses.

For example, in the illustrated embodiment, the pulse signal 190 may be filtered to extract or identify a first subset 194 of the plurality of pulses 192 where each pulse in the first subset 194 has a first frequency or amplitude corresponding to a first diameter (e.g., approximately five micrometers (μm)). Additionally, the pulse signal 190 may be filtered to extract or identify a second subset 196 of the plurality of pulses 192 where each pulse in the second subset 196 has a second frequency or amplitude corresponding to a second diameter (e.g., approximately ten μm). Further, the pulse signal 190 may be filtered to extract or identify a third subset 198 of the plurality of pulses 192 where each pulse in the third subset 198 has a third frequency or amplitude corresponding to a third diameter (e.g., approximately fifteen μm). The pulse signal 190 may be filtered using the one or more filters 106 of the solids detector 40, one or more filters of the controller 44, or one or more filters of any other suitable circuitry or processor-based device.

Additionally, the pulses 192 may be counted or summed over a period of time using the controller 62 and/or the controller 44 to determine a quantity or flow rate of the plurality of solid particles 80. Further, the controller 62 and/or the controller 44 may be configured to determine a quantity or flow rate for each identified diameter of the solid particles 80. For example, the controller 62 and/or the controller 44 may be configured to determine a quantity or flow rate of the pulses 192 in the first subset 194, a quantity or flow rate of the pulses 192 in the second subset 196, and a quantity or flow rate of the pulses 192 in the third subset 198. Additionally, the controller 62 and/or the controller 44 may determine the percentage or concentration of solid particles 80 have a particular diameter relative to a total number of solid particles 80 detected for a period of time. For example, in the illustrated embodiment, the pulse signal 190 includes sixteen pulses 192 over a period of time, and the first subset 194 associated with the first diameter includes four pulses 192. Accordingly, the controller 62 and/or the controller 44 may determine that approximately 25% of the pulses 192 for the period of time have the first diameter.

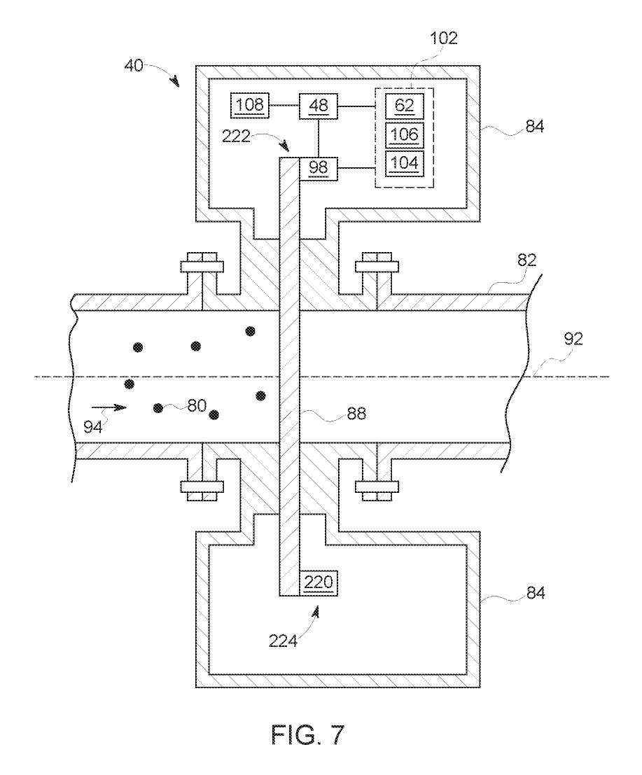

FIG. 7 illustrates an embodiment of the solids detector 40 that includes the receptor 88, the sensor 98, and a second sensor 220. In particular, the receptor 88 may be acoustically coupled to the sensor 98 and the second sensor 220 such that acoustic waves generated by solid particles 80 impacting the receptor 88 are transferred from the receptor 88 to the sensor 98 and the second sensor 220. For example, the sensor 98 and the second sensor 220 may be in physical contact with and/or coupled to the receptor 88. As illustrated, the sensor 98 may be disposed proximate to a first axial end 222 of the receptor 88, and the sensor 220 may be disposed proximate to a second axial end 224 of the receptor 88 opposite from the first axial end 222. The second sensor 220 may be configured to generate an electrical signal (e.g., an electrical pulse signal, an output signal, etc.) varies with (e.g., is proportional to) the impact energies of the one or more solid particles 80 that impacted the receptor 88 similar to the sensor 98. The second sensor 220 may include the magnetostrictive sensor 130, the capacitive sensor 160, the piezoelectric sensor 180, or any other suitable sensor. In some embodiments, the sensor 98 and the second sensor 200 may be the same type of sensor or different types of sensors.

The second sensor 220 may be electrically connected to the circuitry 102, the transmitter 48, and/or the processor 108, and the second sensor 220 may be configured to provide the generated electrical signal (e.g., the electrical pulse signal 190) to the circuitry 102 and/or the transmitter 48, which may transmit the signal to the controller 44, another processor-based device, or the cloud-based system. The controller 62 and/or the controller 44 may be configured to compare the electrical signals generated by the sensor 98 and the second sensor 220 to determine whether the receptor 88 was impacted by a single solid particle 80 or an aggregate or group of solid particles 80. The controller 62 and/or the controller 44 may be configured to triangulate the location of the impact and process the locational information to assess the size of particle impacting the receptor 88 based on the electrical signals generated by the sensor 98 and the second sensor 220 (e.g., based on a comparison of the electrical signal generated by the sensor 98 and the electrical signal generated by the second sensor 220). For example, the electrical signal generated by sensor 98 (e.g., one or more pulses of the electrical signal generated by the sensor 98) and the electrical signal generated by the second sensor 220 (e.g., one or more pulses of the electrical signal generated by the second sensor 220) may have one or more varying characteristics, such as amplitude, phase, shape, and so forth, that may be analyzed by the controller 62 and/or the controller 44 to determine whether the receptor 88 was impacted by a single solid particle 80 or an aggregate or group of solid particles 80, to triangulate the location of the impacts, and/or and to process the locational information to assess the size of the solid particles that impacted the receptor 88.

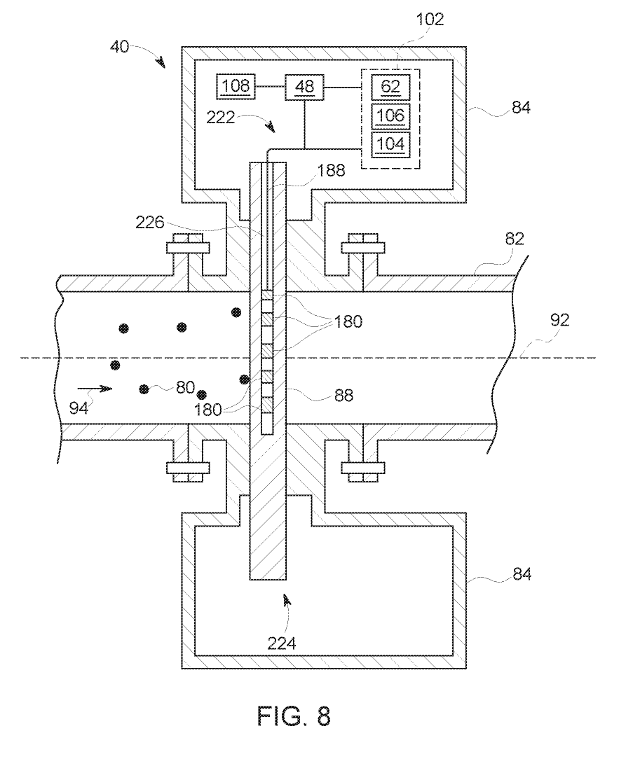

FIG. 8 illustrates an embodiment of the solids detector 40 that includes a plurality of piezoelectric sensors 180 (e.g., an array of piezoelectric sensors 180) embedded in the receptor 88. In particular, the plurality of piezoelectric sensors 180 may be embedded in (e.g., surrounded or enclosed by) the receptor 88 such that the receptor 88 blocks or prevents the fluid in the conduit 82 from contacting the plurality of piezoelectric sensors 180. In this manner, one or more of the piezoelectric sensors 180, or each piezoelectric sensor 180 of the plurality of piezoelectric sensors 180, may be located in the flow path of fluid through the conduit 82 and may be non-rated (e.g., not wet). As illustrated, the plurality of piezoelectric sensors 180 may be disposed in a channel 226 (e.g., an insertion channel) of the receptor 88. It should be appreciated that the piezoelectric sensors 180 may be fixed into place within the channel 226 using any suitable means, such as adhesives, structural supports (e.g., rods), fasteners, and so forth. The channel 226 may extend generally or substantially crosswise to the longitudinal axis of the conduit 82 and/or the flow direction 94 of fluid through the conduit 82. In some embodiments, the channel 226 may extend from

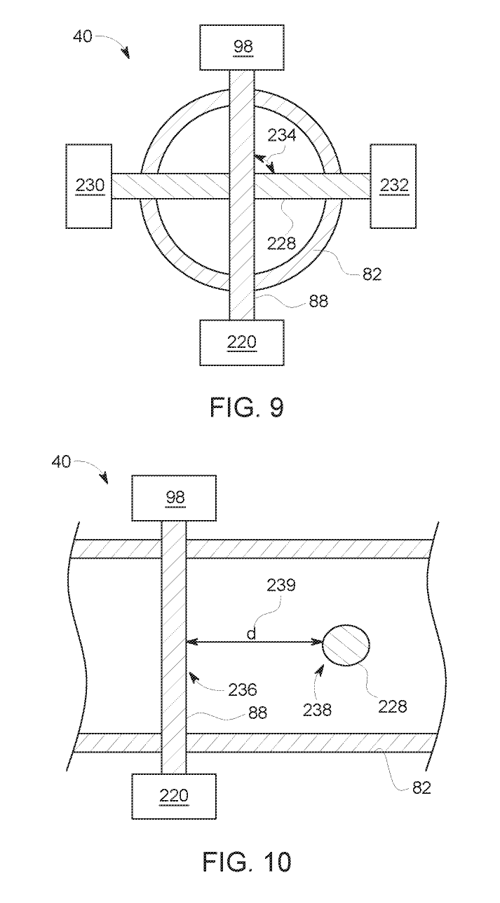

The plurality of piezoelectric sensors 180 may be disposed in any suitable arrangement. For example, in some embodiments, two or more piezoelectric sensors 180 of the plurality of piezoelectric sensors 180 may disposed directly adjacent to one another. In some embodiments, two or more neighboring piezoelectric sensors 180 of the plurality of piezoelectric sensors 180 may be spaced apart from another. Additionally, the leads 188 of the plurality of piezoelectric sensors 180 may extend through the channel 226 to the circuitry 102. In some embodiments, each piezoelectric sensor 180 of the plurality of piezoelectric sensors 180 may be independently connected to the circuitry 102. For example, each piezoelectric sensor 180 of the plurality of piezoelectric sensors 180 may be separately connected to the circuitry 102 via leads 188 of the respective piezoelectric sensor 180. In some embodiments, the controller 62 and/or the controller 44 may be configured to compare the electrical signals generated by the plurality of piezoelectric sensors 180 to determine whether the receptor 88 was impacted by a single solid particle or an aggregate of solid particles. Further, the controller 62 and/or the controller 44 may be configured to determine the locations of the impacts based on analysis of the electrical signals from the plurality of piezoelectric sensors 180 and/or may be configured to use the locational information to assess the size of the solid particles that impacted the receptor 88. In certain embodiments, the solids detector 40 may include two or more receptors 88, where each receptor 88 is coupled to and configured to transfer an acoustic wave to at least one sensor 98. For example, as illustrated in FIG. 9, the solids detector 80 may include the receptor 88 and a second receptor 228. As illustrated, the receptor 88 may be coupled to the sensor 98 and the second sensor 220, and the second receptor 228 may be coupled to a third sensor 230 and a fourth sensor 232. However, it should be appreciated that the receptor 88 and the second receptor 228 may each be coupled to any number of sensors 98, such as one, three, four, five, ten, or more. Further, in certain embodiments, the receptor 88 and/or the second receptor 228 may include one or more sensors 98 (e.g., piezoelectric sensors 180) embedded in the respective receptor as discussed above with respect to FIG. 8. In certain embodiments, the sensors 98 coupled to the second receptor 228 (e.g., the third and fourth sensors 230 and 232) may be electrically connected to the circuitry 102 and/or the transmitter 48.

As illustrated, the second receptor 228 may be disposed at an angle 234 relative to the receptor 88. That is, the second receptor 228 may extend crosswise relative to the receptor 88. In some embodiments, the angle 334 may be between approximately 5 degrees(°) and 175°, 20° and 160°, 35° and 145°, 50° and 130°, 65° and 115°, 80° and 100°, or 85° and 95°. In certain embodiments, the second receptor 228 may be generally perpendicular to the receptor 88. Further, the second receptor 228 may be spaced apart from the receptor 88 along the length of the conduit 82 such that generated acoustic waves are not transferred between the receptor 88 and the second receptor 228. For example, as illustrated in FIG. 10, the receptor 88 may be disposed at a first position 236 along the conduit 82, and the second receptor 228 may be disposed at a second position 238 along the conduit 82. In particular, the first position 236 and the second position 238 may be separated from one another by a distance 239. In some embodiments, the distance 239 may be between approximately one and ten times the diameter 96 (e.g., hydraulic diameter) of the conduit 82. In certain embodiments, the distance 239 may be less than approximately four times the diameter 96 of the conduit 82.

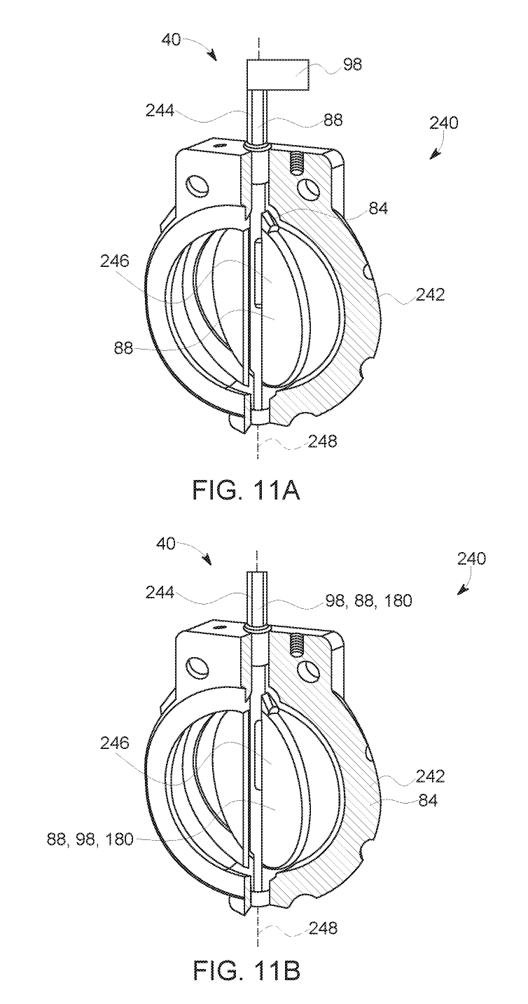

As noted above, in some embodiments, the housing 84 of the solids detector 40 may include the housing (e.g., body) of a valve, such as a butterfly valve, a ball valve, a globe valve, or a gate valve, or the housing of a flowmeter, such as the flowmeter 42. In particular, the receptor 88 and/or the sensor 98 of the solids detector 40 may be disposed in or integrally formed with a valve or a flowmeter. For example, FIG. 11A illustrates a perspective view of an embodiment of the solids detector 40 inserted or integrated in a butterfly valve 240, where the receptor 88 is coupled to the sensor 98. As illustrated, the butterfly valve 240 may include a valve body 242, a valve stem 244, and a valve disc 246. The valve stem 244 and the valve disc 246 may be configured to rotate about a rotational axis 248 of the butterfly valve 240 to regulate the flow through the butterfly valve 240. In certain embodiments, the receptor 88 may be formed or used as the valve stem 244 and/or the valve disc 246. The valve body 242 may be configured to couple to the conduit 82 and may function as the housing 84 of the solids detector 40 that is configured to couple to the receptor 88. Further, the sensor 98 may be coupled to the valve stem 244 (e.g., the receptor 88). FIG. 11B illustrates a perspective view of an embodiment of the solids detector 40 inserted or integrated in the butterfly valve 240, where the receptor 88 and the sensor 98 are integrally formed. In particular, the piezoelectric sensor 180 may function as the receptor 88 and the sensor 98. As illustrated, the piezoelectric sensor 80 may be formed or used as the valve stem 244 and/or the valve disc 246.

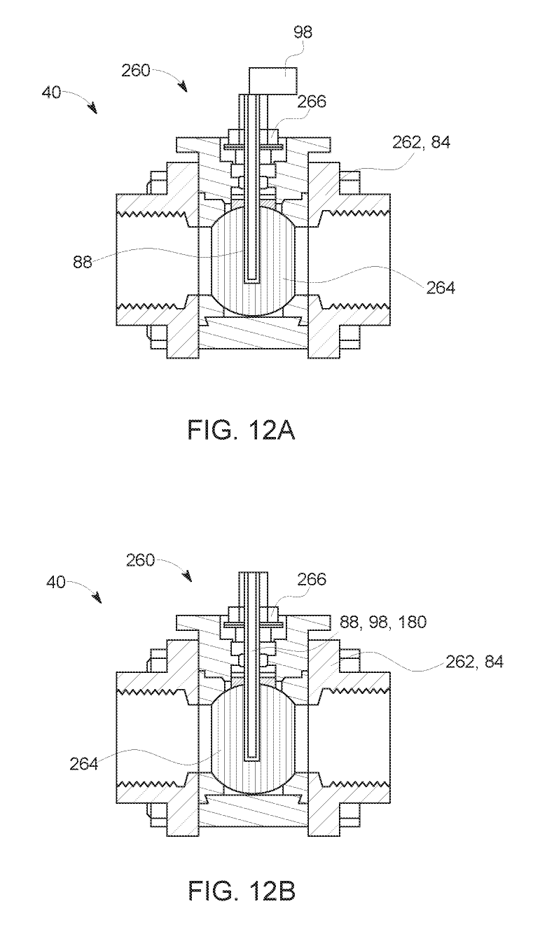

FIG. 12A illustrates a cross-sectional view of an embodiment of the solids detector 40 inserted or integrated in a ball valve 260, where the receptor 88 is coupled to the sensor 98. The ball valve 260 may include a valve body 262, a ball 264 disposed in the valve body 262, and a valve stem 266 coupled to the ball 264. The valve stem 266 may be configured to rotate the ball 264 between an open position where fluid may flow through the ball valve 260 and a closed position where fluid may be blocked from flowing through the ball valve 260. In certain embodiments, the receptor 88 may be inserted in the valve stem 266 and the ball 264 such that the receptor 88 is exposed to fluid flowing through the ball valve 260 when the ball 264 is in the open position and is not exposed to fluid when the ball 264 is in the closed position. Additionally, in some embodiments, the sensor 98 may be coupled to the receptor 88 and/or the valve stem 266. The valve body 262 may be configured to couple to the conduit 82 and may function as the housing 84 of the solids detector 40 that is configured to couple to the receptor 88. As illustrated in FIG. 12B, in certain embodiments, the receptor 88 and the sensor 98 may be integrally formed. In particular, the piezoelectric sensor 180 may function as the receptor 88 and the sensor 98. As illustrated, the piezoelectric sensor 80 may be inserted in the valve stem 266 and the ball 264.

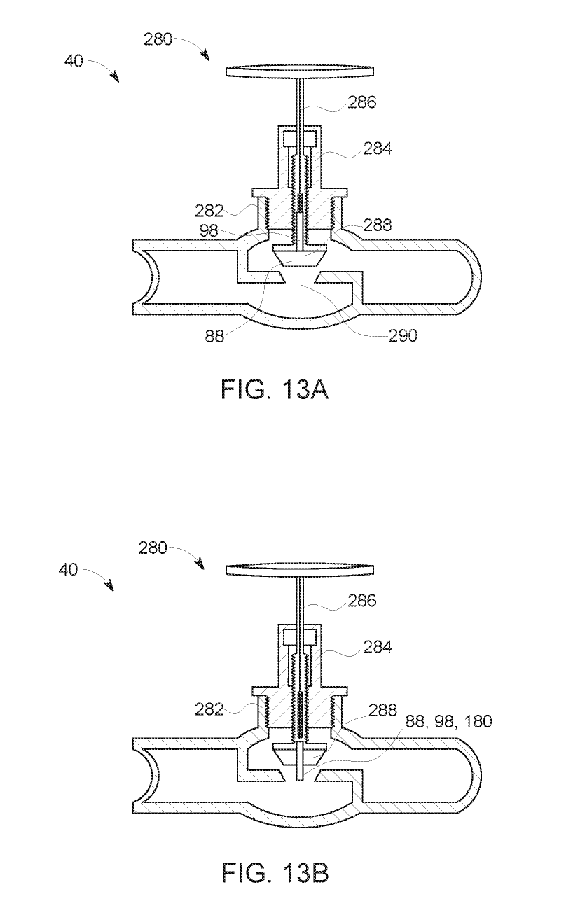

FIG. 13A illustrates a cross-sectional view of an embodiment of the solids detector 40 inserted or integrated in a globe valve 280, where the receptor 88 is coupled to the sensor 98. The globe valve 280 may include a valve body 282, a bonnet 284 coupled to the valve body 282, a stem 286 inserted in and coupled to the bonnet 284, and a plug 288 disposed at an end of the stem 286. Rotation of the stem 286 may raise and lower the plug 288 to open and close a fluid passageway 290 through the valve body 282. In certain embodiments, the plug 288 may function as the receptor 88, and the sensor 98 may be inserted in or integrally formed with the stem 286. The valve body 282 may be configured to couple to the conduit 82 and may function as the housing 84 of the solids detector 40 that is configured to couple to the receptor 88. As illustrated in FIG. 13B, in certain embodiments, the receptor 88 and the sensor 98 may be integrally formed. In particular, the piezoelectric sensor 180 may function as the receptor 88 and the sensor 98. As illustrated, the piezoelectric sensor 80 may be affixed to or integrally formed with the plug 288.

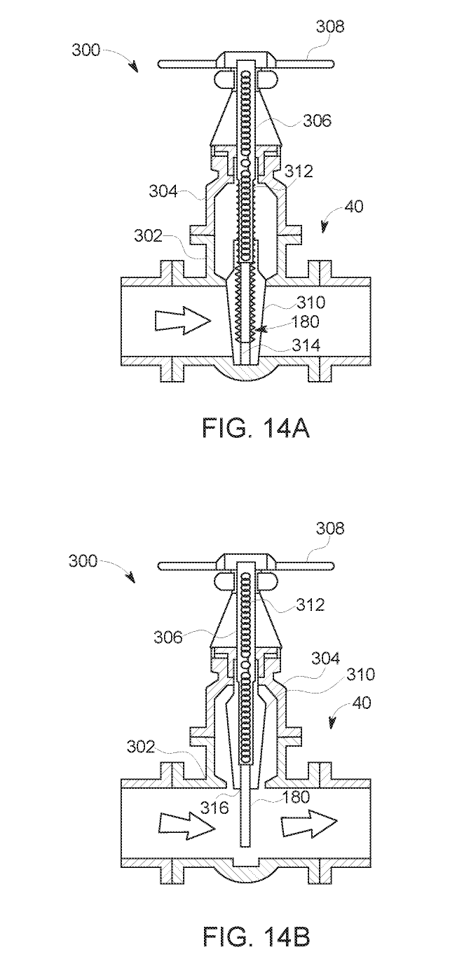

FIG. 14A illustrates a cross-sectional view of an embodiment of the solids detector 40 inserted or integrated in a gate valve 300, showing the gate valve 300 in a closed position. The gate valve 300 may include a valve body 302, a bonnet 304 coupled to the valve body 302, a stem 306 (e.g., an externally threaded stem) inserted in and coupled to the bonnet 304, and a wheel 308 coupled to and configured to rotate the stem 306. Additionally, the gate valve 300 may include a gate 310 (e.g., an internally threaded gate or valve disc) coupled to the stem 306 via the threads. Rotation of the stem 306 via the wheel 308 may raise and lower the gate 310 to enable and block the flow of fluid through the valve body 302. Additionally, in some embodiments, the piezoelectric sensor 180 of the solids detector 40 may be coupled to the stem 306 via a spring 312 disposed in the stem 306. The valve body 302 may be configured to couple to the conduit 82 and may function as the housing 84 of the solids detector 40 that is configured to couple to the receptor 88 (e.g., the piezoelectric sensor 180). As illustrated, when the gate 310 is in the closed position, the piezoelectric sensor 180 may be disposed within a hole 314 (e.g., a bore) that extends through the gate 310. As illustrated in FIG. 14B, the stem 306 may be configured to raise the gate 310 to an open position to enable fluid to flow through the valve body 302. Further, as illustrated, the piezoelectric sensor 180 may be coupled to the spring 312 and may extend past an end 316 of the gate 310 that faces the flow of fluid through the valve body 302 and faces away from the wheel 308. In particular, the piezoelectric sensor 180 may extend into the flow of fluid through the valve body 302.

As discussed above, in some embodiments, the solids detector 40 may include the controller 62, which may be configured to determine one or more solids parameters based on the electrical signal generated by the sensor 98. Additionally, as discussed above, in some embodiments the controller 62 may be configured to execute one or more actions that may reduce or block damage that may be caused by the solid particles 80, such as adjusting the position of (e.g., opening or closing) the bypass valve 54. (see FIG. 1). It should be appreciated that the bypass valve 54 may include the butterfly valve 240, the ball valve 260, the globe valve 280, or the gate valve 300. Accordingly, the controller 62 may be configured to send a control signal to the valve actuator 56 to adjust the position of the butterfly valve 240, the ball valve 260, the globe valve 280, or the gate valve 300.

The controller 44 and/or 62 may include one or more processors, microprocessors, microcontrollers, integrated circuits, application specific integrated circuits, programmable logic controllers, control circuitry, and so forth. Additionally, the controller 44 and/or 62 may include one or more memory devices, which may be provided in the form of tangible and non-transitory machine-readable medium or media having instructions recorded thereon for execution by a processor. The set of instructions may include various commands that instruct the processor to perform specific operations such as the methods and processes of the various embodiments described herein. The set of instructions may be in the form of a software program or application. The memory devices may include volatile and non-volatile media, removable and non-removable media implemented in any method or technology for storage of information such as computer-readable instructions, data structures, program modules or other data. The computer storage media may include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other suitable storage medium.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A solids detector, comprising:
a valve comprising a valve body configured to be coupled to a conduit, wherein the valve is configured to control a flow of a fluid through the conduit;
a receptor coupled to the valve body and configured to extend at least partially into a flow path of the fluid through the valve body; and
a sensor coupled to the valve body and the receptor, wherein the sensor is configured to receive an acoustic wave generated due to one or more solid particles in the fluid impacting the receptor, wherein the sensor is configured to generate an electrical signal based on the acoustic wave, and wherein the electrical signal is indicative of one or more impact energies of the one or more solid particles that impacted the receptor.

2. The solids detector of claim 1, wherein the sensor comprises a piezoelectric sensor.

3. The solids detector of claim 1, wherein the sensor comprises an array of piezoelectric sensors embedded in the receptor along a portion of the receptor that extends into the flow path.

4. The solids detector of claim 1, wherein the sensor comprises a magnetostrictive sensor.

5. The solids detector of claim 4, wherein the magnetostrictive sensor comprises:
a magnetostrictive element affixed to and configured to receive the acoustic wave from the receptor, wherein the acoustic wave is configured to cause a change in a magnetic permeability of the magnetostrictive element;
a magnetic field generating device configured to induce a magnetic flux in the magnetostrictive element, wherein the change in the magnetic permeability of the magnetostrictive element is configured to cause a change in the magnetic flux of the magnetostrictive element; and
a magnetic field detecting device configured to detect the change in the magnetic flux of the magnetostrictive element and to generate the electrical signal based on the change in the magnetic flux.

6. The solids detector of claim 1, wherein the sensor comprises a capacitive sensor.

7. The solids detector of claim 1, wherein the valve comprises a butterfly valve comprising a valve stem and a valve disc, wherein the valve stem and the valve disc are configured to rotate about a rotational axis of the butterfly valve to control the flow of the fluid through the conduit, and wherein the receptor comprises the valve stem and the valve disc, and wherein the sensor is coupled to the valve stem.

8. The solids detector of claim 1, wherein the valve comprises a ball valve, wherein the ball valve comprises a ball disposed in the valve body and a stem coupled to and configured to rotate the ball between an open position and a closed position, and wherein the receptor is configured to be inserted in the valve stem and the ball such that the receptor is exposed to the fluid when the ball is in the open position.

9. The solids detector of claim 1, comprising a controller configured to send a control signal to an actuator coupled to the valve, wherein the control signal is configured to cause the actuator to adjust a position of the valve to control the flow of the fluid through the conduit.

10. The solids detector of claim 9, wherein the controller is configured to:
receive the electrical signal from the sensor;
determine at least one parameter of the one or more solid particles based on the electrical signal; and
determine the control signal based at least in part on the at least one parameter.

11. The solids detector of claim 1, wherein the electrical signal comprises a plurality of pulses, wherein each pulse of the plurality of pulses is indicative of the impact energy of a respective solid particle of the one or more solid particles that impacted the receptor, and wherein the solids detector comprises a controller configured to:
determine a size of each solid particle of the one or more solid particles that impacted the receptor based on an amplitude or a frequency of the pulse associated with the respective solid particle; and
determine a flow rate of the solids particles in the fluid by summing the plurality of pulses over a period of time.

12. A system configured to produce oil and gas from a well, comprising:
a conduit configured to flow a fluid produced by the well;
a solids detector coupled to the conduit and configured to generate an electrical signal in response to detecting one or more solid particles in the fluid; and
a controller configured to receive the electrical signal from the solids detector and to determine an action based at least in part on the electrical signal, wherein the action, when executed, adjusts a flow rate of the fluid through the conduit or adjusts a flow path of the fluid through the system.

13. The system of claim 12, comprising an output device, wherein the controller is configured to cause the output device to provide a user-perceivable indication indicative of the action determined by the controller.

14. The system of claim 12, comprising:
a choke coupled to the conduit; and
a choke actuator configured to adjust a position of the choke, wherein the action determined by the controller comprises adjusting the position of the choke to adjust the flow rate of the fluid through the conduit.

15. The system of claim 14, wherein the controller is configured to send a control signal to the choke actuator that causes the choke actuator to adjust the position of the choke.

16. The system of claim 12, comprising:
a bypass valve disposed in the conduit, wherein the bypass valve is configured to enable the fluid to flow to a fluid processing device when the bypass valve is in a first position and to block the fluid from flowing to the fluid processing device when the bypass valve is in a second position, and wherein the action determined by the controller comprises adjusting the bypass valve from the first position to the second position to adjust the flow path of the fluid through the system.

17. The system of claim 16, wherein the controller is configured to send a control signal to a valve actuator that causes the valve actuator to adjust the bypass valve from the first position to the second position.

18. The system of claim 16, wherein the solids detector comprises:
a receptor coupled to a valve body of the bypass valve, wherein the receptor is configured to extend at least partially into a flow path of the fluid through the valve body, wherein the receptor is configured to generate an acoustic wave due to the one or more solid particles in the fluid impacting the receptor; and
a sensor coupled to the valve body and the receptor, wherein the receptor is configured to transfer the acoustic wave to the sensor, and wherein the sensor is configured to generate the electrical signal based on the acoustic wave, wherein the electrical signal is indicative of one or more impact energies of the one or more solid particles that impacted the receptor.

19. The system of claim 18, wherein the controller is coupled to the valve body of the bypass valve.

20. The system of claim 16, comprising a solids tank, wherein the bypass valve is configured to route the fluid to the solids tank when the bypass is in the second position.

21. A solids detector, comprising:
a receptor configured to extend at least partially into a flow path of a fluid through a conduit, wherein the receptor is configured to generate an acoustic wave in response to one or more solid particles impacting the receptor, and wherein the receptor comprises a first end and a second end opposite the first end;
a first sensor coupled to the first end of the receptor; and
a second sensor coupled to the second end of the receptor, wherein the receptor is configured to transfer the acoustic wave to the first and second sensors, and wherein the first and second sensors are configured to generate first and second electrical signals, respectively, based on the acoustic wave, and wherein the first and second electrical signals are each indicative of one or more impact energies of the one or more solid particles that impacted the receptor.

22. The solids detector of claim 21, wherein the first sensor comprises a magnetostrictive sensor, and wherein the magnetostrictive sensor comprises:
a magnetostrictive element affixed to the first end of the receptor and configured to receive the acoustic wave from the receptor, wherein the acoustic wave is configured to cause a change in a magnetic permeability of the magnetostrictive element;
a magnetic field generating device configured to induce a magnetic flux in the magnetostrictive element, wherein the change in the magnetic permeability of the magnetostrictive element is configured to cause a change in the magnetic flux of the magnetostrictive element; and
a magnetic field detecting device configured to detect the change in the magnetic flux of the magnetostrictive element and to generate the first electrical signal based on the change in the magnetic flux.

23. The solids detector of claim 21, wherein the first sensor comprises a capacitive sensor, and wherein the capacitive sensor comprises:
a first conductive plate;
a second conductive plate separated from the first conductive plate by a gap filled with a dielectric;
wherein the first end of the receptor is affixed to and configured to transfer the acoustic wave to the first conductive plate, wherein the acoustic wave is configured to cause a change in a size of the gap, and wherein the capacitive sensor is configured to generate the first electrical signal based on a change in capacitance caused by the change in the size of the gap.

24. The solids detector of claim 21, comprising a valve comprising a valve body configured to be coupled to the conduit, wherein the valve is configured to control a flow of the fluid through the conduit, and wherein the receptor, the first sensor, and the second sensor are configured to be coupled to the valve body.

25. The solids detector of claim 21, comprising a second receptor configured to extend at least partially into the flow path of the fluid through the conduit, wherein the second receptor is configured to generate a second acoustic wave in response to one or more second solid particles impacting the second receptor, wherein the second receptor is separated from the receptor by a distance along a length of the conduit, and wherein the second receptor extends crosswise relative to the receptor;
a third sensor coupled to a first end of the second receptor; and
a fourth sensor coupled to a second end of the second receptor, wherein the second receptor is configured to transfer the second acoustic wave to the third and fourth sensors, wherein the third sensor and the fourth sensor are configured to generate a third electrical signal and a fourth electrical signal, respectively, based on the second acoustic wave, wherein the third and fourth electrical signals are each indicative of one or more impact energies of the one or more second solid particles that impacted the second receptor.

26. The solids detector of claim 21, wherein the first sensor comprises a piezoelectric sensor.
